(19) United States
(12) Patent Application Publication
(10) Pub. No.: US 2006/0229894 A1
(43) Pub. Date: Oct. 12, 2006

(54) System and method for estimating expense and return on investment of a dynamically generated runtime solution to a business problem

(76) Inventor: Ingrid M. Moulckers, Austin, TX (US)

Correspondence Address: Greg Goshorn, P.C., 9600 Escarpment, auite 745-9, AUSTIN, TX, 78749, US

(21) Appl. No.: 11/103,852

(22) Filed: Apr. 12, 2005

(51) Int. Cl. G06Q 99/00; G06F 17/00

(52) U.S. Cl. 705/1; 705/400

(57) ABSTRACT

Provided is a method for estimating expenses and return on investment (ROI) in a dynamically generated business solution based upon reusable components. Each component is assigned to one or more categories based upon attributes such as the business problems that the particular component addresses. Categories are also based upon particular industries, integration points between components, solution areas and other criteria, including the experience of typical users. To address a specific business problem, one or more appropriate core business components are selected. Additional components are selected by a generation engine based upon the selected core components, their corresponding categories. Once selected, each of the components is assigned an expense, the expense of each component reflecting the expected cost to operate the corresponding component in the business solution. A ROI is generated based upon the expense and a cost associated implementing the system.

### TECHNICAL FIELD

The present invention relates generally to project management and, more specifically, to a method for estimating expenses and return on investment associated with a dynamically generated business solution.

### BACKGROUND OF THE INVENTION

International Business Machines Corp. (IBM) of Armonk, N.Y. has been at the forefront of new paradigms in business computing. For decades, the typical paradigm for business computing is that custom business applications had to be specifically designed and built for every business need. Of course, most custom business applications benefited from commonly-available, standardized applications. For example, a business that requires a database management system (DBMS) has several vendors from which to choose and each choice typically provides many of the same necessary features and interfaces to an application developer. However, a DBMS is only one of a multitude of possible components that may be required to implement a business solution.

There are several approaches to the development of a business software solution for a particular business. One approach involves an independent software vendor (ISV) who integrates software components into an “application package.” Another approach involves a system integrator (SI) who integrates software and hardware components and application packages. The SI determines required functionality, selects commercially available hardware and software components that implement portions of the required functionality and generate a final “solution package.” In addition to any tasks performed by a SI, a solution provider (SP) may produce custom software to integrate and enhance the commercially available hardware and software components and infrastructure software. The terms SI and SP are often used interchangeably. The software components that an ISV or SP integrate with software components is called custom code (sometimes also called “application” or “glue” code). Examples of typical software components include, but are not limited to, an IBM HTFP Server and associated plug-ins, a WebServer Application Server-Express runtime application and an IBM DB2 Universal Database (UDB) component.

The ISV would typically integrate such components in conjunction with their application code and then package and/or deploy this application package via some type of computer memory such as a compact disk (CD), a file-transfer-protocol (ftp) site, or memory associated with a computer file server. The SI would typically integrate such components, including the application package or packages in conjunction with their custom, or glue code, and then package and/or deploy this solution package via some type of computer memory such as a compact disk (CD), a file-transfer-protocol (ftp) site, or memory associated with a computer file server

Two terms that may be useful to clarify are the terms “application” and “solution.” In some cases, an application solves several problems and as a result may be considered a solution. However, usually the term “solution” refers to an application because a solution solves a target set of problems, although some ISVs call their applications a solution. A solution is usually broader than an application because it resolves or addresses horizontal as well as vertical business problems. Solutions are typically delivered for the purpose of running a business end-to-end and not just focused on a portion (or application of the business). An application is applied to solve a set of problems for a business and might be applied to solve another set of problems of the same kind for another customer.

What is needed is a listing of available hardware and software components, along with information on each component's functions and dependencies. By employing such a list, an ISV or SI can assemble a custom deployment package for a particular business such that the business and the ISV or SI can be assured that the package, whether an application package or solution package, includes all required functionality without including any unnecessary components.

### SUMMARY OF THE INVENTION

Provided is a method for estimating system expenses and return on investment (ROI) associated a dynamically generated business solution based upon reusable components. Components include, but are not limited to, hardware, executable logic for performing specific functions, user manuals, procedural manuals and other documentation corresponding to particular hardware and software. A Solutions Runtime and Value Assets Assembly (SRVAA) toolset is employed to dynamically generate the business solution. ROI is a common business term that should be understood by those with skill in the business arts.

Each component is assigned to one or more categories based upon attributes such as the business problems that the particular component addresses. Categories are also based upon particular industries, integration points between components, solution areas and any other criteria. Category criteria may include the experiences of typical users. Categories enable interdependencies among components to be defined so that, for example, a component that includes executable logic can be associated with a component that includes a corresponding user manual.

To address a specific business problem, one or more appropriate core business components are selected. Additional components are selected by the SRVAA toolset based upon the selected core components, their corresponding categories and the particular industry to which the business problem is associated. Once components are selected, each of the selected reusable components is assigned an expense value, wherein the value associated with each component reflects the expected expense to operate the corresponding component in a business solution. The expense values are totaled to arrive at a total expense figure for the business solution. Also calculated is a ROI value based upon the projected expenses and cost of deploying the business solution. Also provided is means for entering, once the business solution has been deployed, actual cost and expense figures into the SRVAA toolset so that an actual ROI can be calculated.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of a solution development system that employs the claimed subject matter.

FIG. 2 is a block diagram of the system of FIG. 1 in more detail, showing some exemplary components and application distribution elements.

FIG. 3 is a block diagram of the Solutions Runtime and Value Assets Assembly (SRVAA) toolset of FIGS. 1 and 2.

FIG. 4 is a block diagram of various assets, or components, and some of the relationships among the components.

FIG. 5 is a block diagram illustrating exemplary tasks of a typical business solution.

FIG. 6 is a block diagram illustrating details of an implementation guide, first introduced in FIG. 5.

FIG. 7 is a block diagram illustrating details of a demo toolkit, first introduced in FIG. 5.

FIG. 8 is a flowchart of a process that assembles a custom business solution according to the claimed techniques.

### DETAILED DESCRIPTION OF THE FIGURES

Although described with particular reference to a few specific examples, the claimed subject matter can be implemented in any information technology (IT) system in which modular software components are desirable. Those with skill in the computing arts will recognize that the disclosed embodiments have relevance to a wide variety of computing environments in addition to those described below.

As described to in the Summary of the Invention section, there are a number of types of technical experts who may deploy and/or employ the claimed subject matter, e.g. a developer, an independent software vendor (ISV), a system integrator (SI) or a solution provider (SP). A final business product may also be referred to as an ISV, SI or SP solution package. For the sake of simplicity the remainder of the specification will primarily refer to SIs, although it should be understood that most described tasks may be performed by developers, ISVs or SPs as well, and ISV solution packages.

In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC), application server and mainframe.

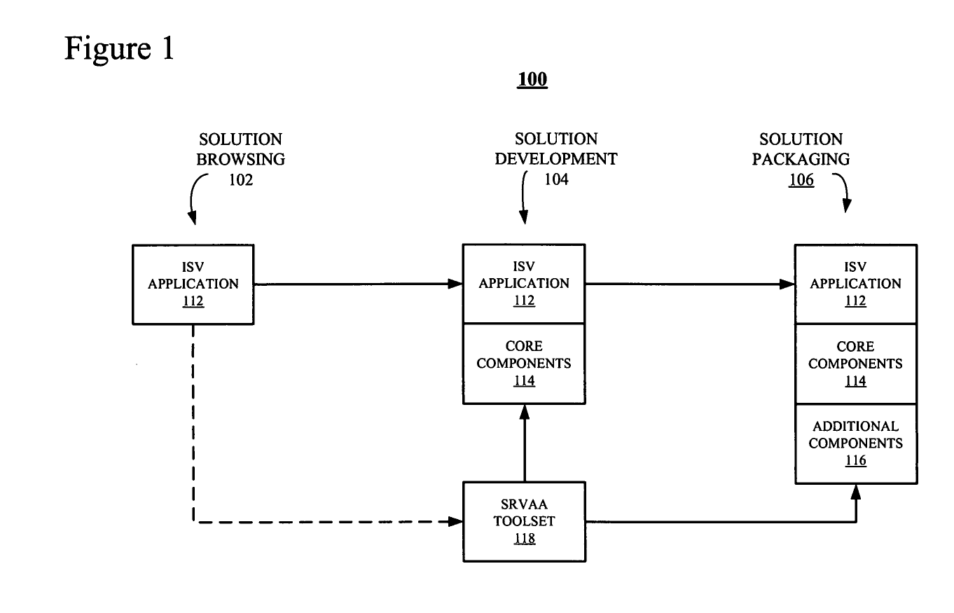

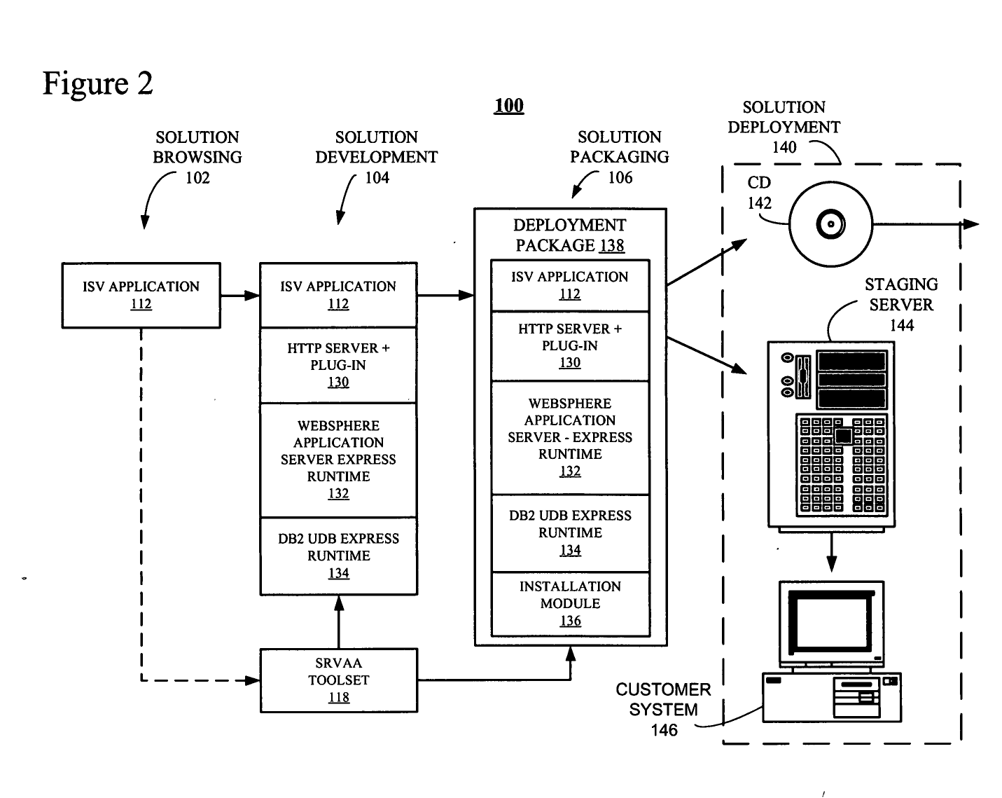

Turning now to the figures, FIG. 1 is a block diagram of a solution development system 100 that employs the claimed subject matter. In particular software markets, an SI delivers custom business solutions. The process can be broken into at least three (3) distinct phases: solution browsing 102, solution development, or solution composing, 104; and solution packaging 106. Solution testing is a subset of the solution development 104. What might be considered a fourth phase, solution deployment phase 140, is described below in conjunction with FIG. 2.

During solution browsing 102 an SI accesses a Solutions Runtime and Value Assets Assembly (SRVAA) toolset 118 that enables the SI to select components, such as an ISV application 112, which the SI determines is necessary for inclusion in the proposed business solution, for listing on a manifest. It should be noted that there may be any number of applications and other types of components selected, such as ISV application 112, each of which may be created by technical experts or an off-the-self product.

In this example, a SI selects or creates custom software and other components for providing functionality that is specific to the particular business problem during solution browsing 102. SRVAA toolset 118 assists this process by providing the capability to view the name and associated characteristics of all available components.

During solution development 104, core components 114 are added to ISV application 112 to provide standard business functionality. For example, ISV application 112 such as an entry order system needs to be paired with, among other things, a core component 114 such as a database management system (DBMS). Core components 114 may be either “off-the-shelf” or off-the-shelf applications and/or devices.

One essential element of the SI's job is to select sufficient core components 114 without adding any unnecessary components. Typically, customers either will not or can not pay for unnecessary components. SRVAA toolset 118 assists in this task by providing suggestions of components or types of functional components that the SI might need to include in the ultimate business solution. Another aspect of solution development 104 is that SRVAA toolset 118 verifies components, i.e. dependencies and requirements of selected components are checked to ensure that nothing necessary has been omitted.

During solution packaging 106, the SI typically provides addition components 116 as needed. For example, in addition to ISV application 112, such as an order entry system, and core components 114, such as a DBMS, the SI may need to provide a component with functionality to retrieve data over a network such as the Internet or a component that decompresses computer memory files and installs solution packaging 106 on a target system such as a customer system 146 (see FIG. 2). User manuals may also be provided.

One of the difficult aspects of the development model illustrated in system 100 is the determination of both core components 114 and additional components 116. As stated upon, the SI must be sure that necessary functionality is present without making the client pay for unnecessary components. SRVAA toolset 118 simplifies this issue. Using information about ISV application 112 (and any additional applications that may be present), SRVAA toolset 118 determines core components 114 necessary for solution development 104. Further, during solution packaging 106, SRVAA toolset 118 determines additional components 116 necessary for a full implementation of the proposed business solution. SRVAA toolset 118 is described in more detail below in conjunction with FIGS. 2-8.

FIG. 2 is a block diagram of solution development system 100 of FIG. 1 in more detail, showing some exemplary components and business solution distribution elements. System 100, solution development 102 (FIG. 1), solution packaging 106 (FIG. 1), ISV application 112 (FIG. 1) and SRVAA toolset 118 (FIG. 1) are also shown in FIG. 2. In addition, a solution deployment phase 140 is shown. Solution deployment 140 illustrates some methods of distributing solution packaging 106 to an eventual client or customer.

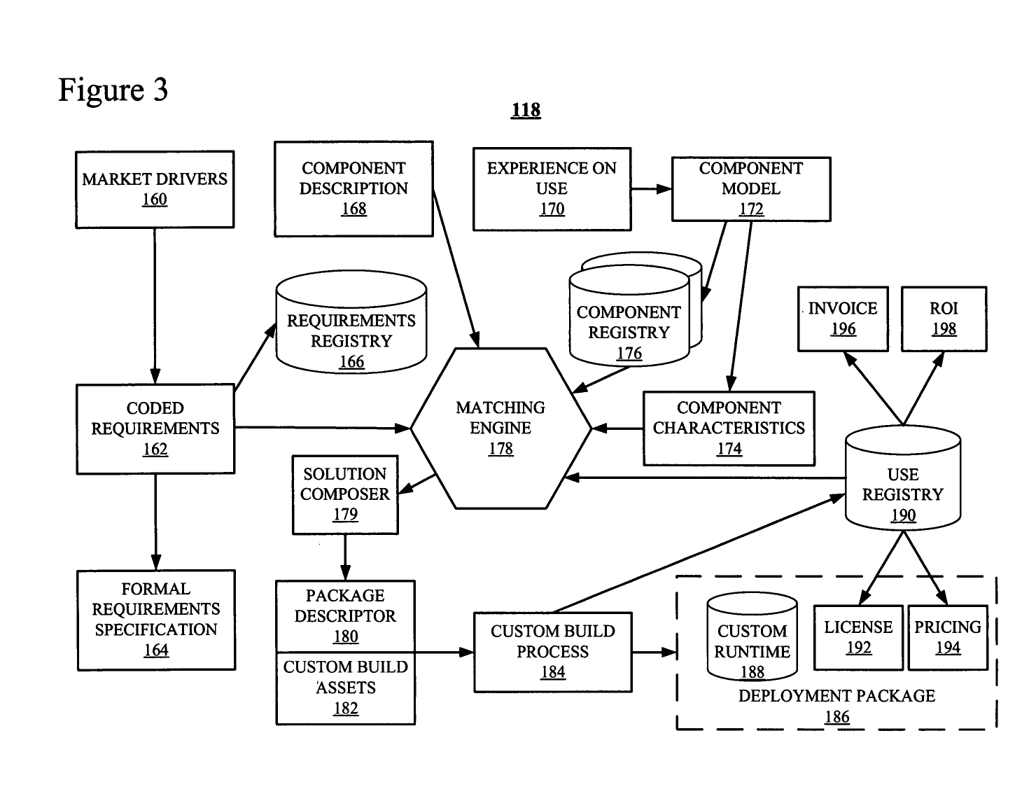

Examples of such distribution techniques include, but are not limited to, a compact disk (CD) 142, which is mailed or otherwise delivered to the customer for installation on a customer system 146; and a staging server 144, from which customer system 146 can download a product of solution packaging 106, such as a deployment package 186 (see FIG. 3). Those with skill in the computing arts should recognize that there are many possible delivery options in addition to CD 142 and staging server 144. Further, there are many possible customer configurations, of which customer system 146 is only one simple example.

Solution development 104 is illustrated with specific examples of typical, exemplary core components 114 (FIG. 1) one might find in an actual system. A HTRP server and associated plug-ins 130, a Websphere application server express runtime module 132 and a DB2 universal database (UDB) express runtime module 134 provide necessary functionality to ISV application 112. Once development proceeds into solution packaging 106, a deployment package 138 is produced for delivery via, in this example, either CD 142 and/or staging server 144. In deployment package 138, an example of an additional components 116 (FIG. 1) is shown, specifically an installation module 136. Installation module 136 decompresses and installs the computer files of solution package 138 onto, in this example, customer system 146.

FIG. 3 is a block diagram of the Solutions Runtime and Value Assets Assembly (SRVAA) toolset 118 of FIGS. 1 and 2 in more detail. SRVAA toolset 118 would typically execute on a computing system (not shown) with one or more processors (not shown) and memory (not shown), both volatile and non-volatile. Those with skill in the computing arts should appreciate that there are many possible configurations of computing systems that are capable of implementing the claimed subject matter. Further, one with skill in the art should understand how memory and processors work together to store and execute the claimed subject matter.

SRVAA toolset 118 includes a market drivers module 160, a coded requirements module 162, a formal requirements specification module 164, a requirements registry 166, a component description module 168, an experience on use module 170, a component model 172, a component characteristics module 174, a component registry 176, a matching engine 178, a solution composer module 179, a package descriptor module 180, a custom build assets module 182, a custom build process module 184 and a use registry 190. SRVAA produces a custom runtime package 188, a license information artifact 192, a pricing information artifact 194, an invoice information artifact 196 and a return on investment (ROI) information artifact 198. An information artifact is an object that stores and/or displays information, such as, but not limited to, a document or a display screen (not shown).

Market drivers module 160 includes information and logic relating to a particular industry. Typically, different industries would each have corresponding drivers. The particular market driver 160 selected by matching engine 178 would be based upon the industry for which the business solution is designed. Market drivers module 160 feeds information into codes requirement module so that the resultant business solution accurately reflects the industry to which it is targeted. Coded requirements 162 is an information artifact that specifies a top-level view of that which custom build process module 184 provides. Typically, coded requirements 162 employs a “manifest,” which is a high-level list of components that the proposed business solution requires. The manifest is generated by a developer, ISV, SI, SP, etc., i.e. anyone with the subject matter expertise in the particular industry to create such list. The manifest is augmented by SVAA toolkit 118 as described below and can be “leveraged” by other subject matter experts to create “derived” manifests corresponding to other business solutions.

Formal requirements specification 164 is based upon the result of work product of coded requirements 162 and details the solution to a particular business problem, i.e. exactly what functionality a solution must provide. Requirements registry 166 is a data repository that stores information relating to requirements that have been produced by coded requirements module 162 for multiple situations. In addition, requirements registry 166 is a source of examples and templates of possible requirement documents for coded requirements 162 based upon the stored historical information.

Component description module 168 includes data on possible components available for a custom business solution; may include off-the-self products as well as libraries of previously developed modules. Components may include hardware, software and related documentation. Experience on use module 170 includes data, based upon experience, e.g. the requirements of a particular industry corresponding to the desired business solution. Component Model 172 is a list of the required components for a particular business solution, based upon experience on use module 170. Component model 172 provides information to component characteristics module 174 and component registry 176.

Component characteristics module 174 includes data relating to characteristics of available components, including such information as, but not limited to, relations to particular industries, hardware requirements, software dependencies, size and execution factors, available user manuals, and related installation and startup scripts. It should be noted that both hardware and software components have specific characteristics, some of which are shared. Component registry 176 is a list of components available for a business solution.

Matching Engine 178 is executable logic that correlates the elements of coded requirements 162, component descriptions 168, component registry 176, component characteristics 174 and use registry 190 to produce a manifest and transmits the manifest to solution composer 179. Solution composer 179 generates custom build specification 180, which then corresponds to the desired business solution. In other words, solution composer 179, based upon the manifest produced by matching engine 178, produces custom build specification 180, which is a list of components necessary for a proposed business solution, including all necessary hardware and software and related documentation. Prior to transmittal to solution composer 179, matching engine 178 also verifies the manifest, i.e checks to ensure that the listed components will work together and do not include any dependencies to components that are not include on the list.

Custom Build Assets 182 is a list of the assets necessary to create a custom business solution, as detailed in package descriptor 180. Custom Build Process 184 is executable logic for assembly all the software components necessary for the installation, setup and execution of package descriptor 180, and then packaging the components listed in custom build assets 182 into a form that can be transmitted to a customer (see FIG. 2). In addition, custom build process 184 transmits information relating to generated business solutions to use registry 190, which is described in more detail below.

Deployment package 186 can be, for example, a packaged application initiated by an ISV or a solution package initiated by an SI, and generated by custom build process 184. Deployment package 186 includes all the software, hardware and technical support necessary to implement a business solution. Deployment package 186 includes custom runtime 188, license 192 and pricing 194. Custom runtime 188 is executable logic for implementing a business solution. Use Registry 190 is data relating to installed and proposed business solutions, used to generate license 192 and pricing 194 as part of a complete business solution such as deployment package 186. Use registry 190 also provides feedback to matching engine 178 so that matching engine 178 is able to information from prior business solutions.

License 192 is an information artifact that stores an agreement concerning the terms of the proposed business solution. License 192 is generated based upon the specific components of the business solution and the practices of the industry to which the solution relates. Pricing 194 is an information artifact such that stores a statement transmitted to a customer corresponding to the cost of a proposed business solution. Invoice 196 is an information artifact that stores a bill or bills transmitted to a customer corresponding to an executed business solution. ROI 198 is an information artifact that creates and stores a calculation based upon the cost of a solution with respect to the expected benefit of the solution. ROI 198 also includes a calculation of the period of time it will take for the proposed business solution to pay for itself, or reach a breakeven point. Information in pricing 194, invoice 196 and ROI 198 can also be actual data related to a finctioning business solution.

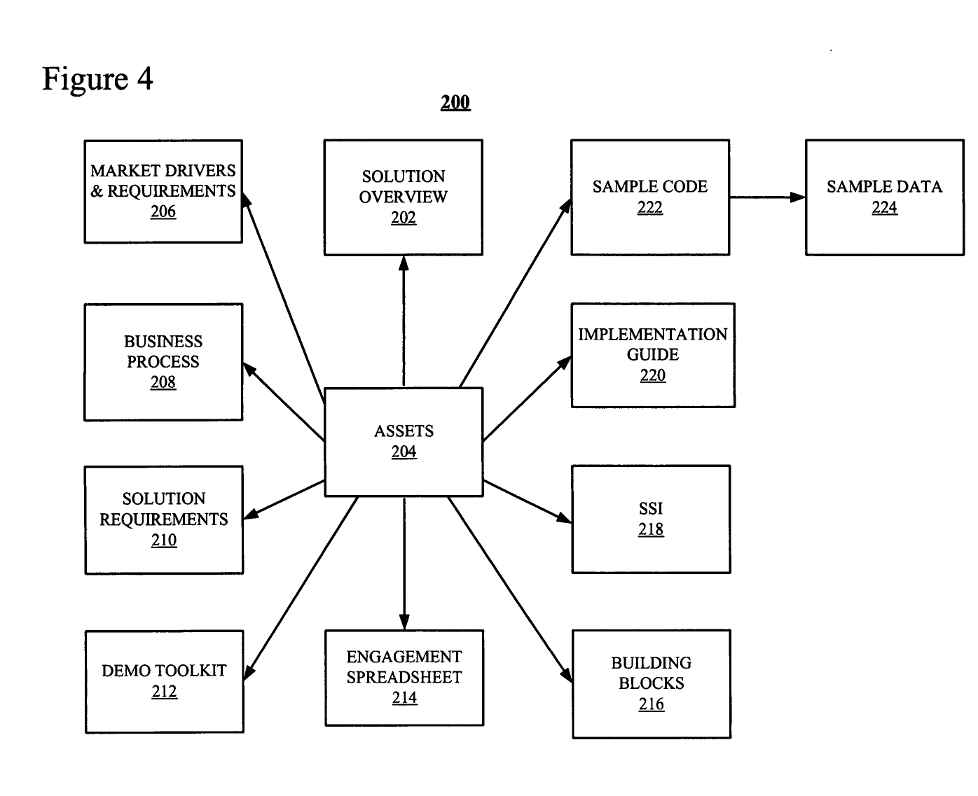

FIG. 4 is a block diagram of a model 200 of various assets, or components, of SRVAA toolset 118 (FIG. 3), detailing relationships among the components and some products of toolset 118. Model 200 includes a solution overview module 202, an assets and artifacts module 204, a market drivers and requirements module 206, a business process module 208, a solutions requirements module 210, a demo toolkit 212, an engagement spreadsheet 214, a building block module 216, a solution starting point installer (SSI) 218, an implementation guide 220, a sample code module 222 and a sample data module 224.

Solution overview 202 is a high-level diagram of a business solution that facilitates the understanding of solution concepts, business value and system architecture and provides assistance with customer engagement. Assets and artifacts 204 includes all elements necessary to design, market, implement and deploy a business solution. Typically, the term “assets” is used with regards to a set of materials that are programming code. The term “artifacts” is used to refer to all materials or any type. Artifacts are typically more equated to information (text) materials, but the word “artifacts” can be used in place of the word “assets.” The phrase “informational assets” is used to mean those information artifacts that are basically textual in nature, regardless of the format or tool used to create or author them.

Market drivers & requirements 206 is data relevant to a particular industry used for designing and implementing a business solution for that particular industry. Business process 208 is a proposed or implemented business solution. Solution requirements 210 is a list of components, or assets, necessary to implement a business solution.

Demo toolkit 212 provides customizable assets to assist the ISV, SI or SP in creating a demonstration for marketing a custom solution. Engagement spreadsheet 214 is a spreadsheet containing information about resources and time corresponding to technical personnel relating to the implementation of a particular business solution. Building Block 216 includes functional components that are the basis for a business solution. When building blocks 216 are leveraged together solutions can be developed in an accelerated method to meet customers current and future needs.

SSI 218, or “solution starting point installer” is a set of solution files that automate the installation, configuration and deployment steps that are documented in implementation guide 220. SSI 218 deploys a solution starting point. A solution starting point is a proof-of-concept of a business solution, i.e. a demonstration of what a proposed solution looks like and can do once implemented. Implementation Guide 220 includes directions for implementing a business solution and may provide a structured learning opportunity that enables an ISV, SI or SP not only to establish an instance of a potential solution but also to learn important techniques for development and deployment.

Sample code 222 includes sample code, scripts, configurations to speed up the development and deployment of a business solution. Sample code is correlated to particular business models. Sample Data 224 is sample data employed in conjunction with sample code to generate a demonstration of a proposed business solution or employed with an actual business solution to demonstrate or test the business solution.

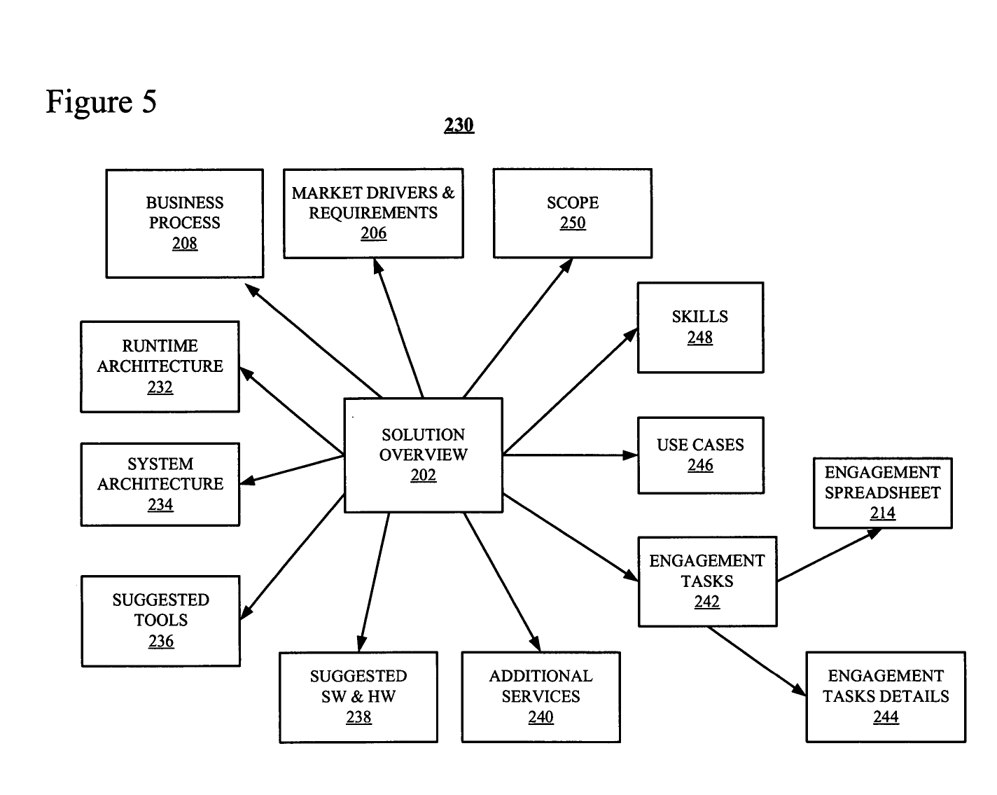

FIG. 5 is a block diagram illustrating exemplary tasks associated with a typical business solution 230. Solution overview 202, market drivers & requirements module 206, business process 208 and engagement spreadsheet 214 were introduced above in conjunction with FIG. 4.

A runtime architecture module 232 represents a software configuration of implemented business solution, such as business solution 202. System architecture 234 is a hardware configuration of the implemented business solution. System architecture 234 illustrates how the systems “looks” once the solution has been deployed, including the system's correlation to any existing system in an operating environment.

Suggested tools 236 are proposed documentation, installation and setup components of a potential business solution. Suggested SW & HW 238 are proposed software and hardware components of a potential business solution. Additional services 240 are proposed technical services provided in conjunction with a potential business solution.

Engagement tasks module 242 represents an overview of all the tasks necessary to implement a proposed business solution and is a component of engagement tasks 242. Engagement task details 244 is a detailed list of tasks and corresponding timelines to implement a proposed business solution and is also a component of engagement tasks 242. Use Cases 246 is information relating to case studies of actual business solutions; used to design and market proposed business solutions. Skills module 248 is information related to personnel skill sets necessary to implement a proposed business solution. Scope module 250 is information specifying all areas of a business that are affected by a proposed business solution.

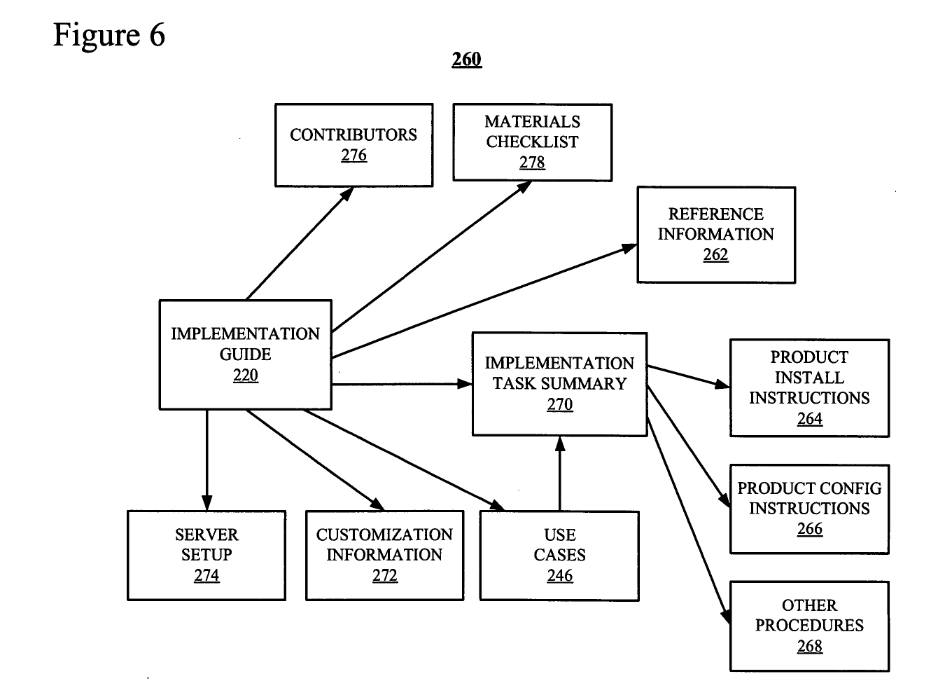

FIG. 6 is a block diagram of a breakdown 260 of implementation guide 220, first introduced in FIG. 4. Use cases 246 was first introduced above in conjunction with FIG. 5.

Reference information 262 is information such as, but not limited to, help files. Product install instructions 264 is information and scripts necessary to install and setup the executable logic of a particular business solution. Product config instructions 266 is information relating to the configuration options available in conjunction with a particular business solution. Other procedures 268 are any potential procedures not covered by the four categories above.

Product install instructions 264, product config instructions 266 and other procedures 268 represent a breakdown of an implementation task summary 274, which is an overview of the tasks necessary to install and setup a particular business solution. Implementation task summary 270 also includes information from use cases 246, which enables SVAA toolset 118 (FIG. 3) to take advantage of previous user experiences. This feedback mechanism helps ensure that the resultant business solution is both more efficient and effective than is otherwise possible.

Customization information 272 is information relating to modifications of standard components performed in the implementation of a business solution. Server setup 274 is information relating to the configuration of hardware that executes a particular business solution. Contributors 276 is a list of technical personnel involved in the design, creation and implementation of a particular business solution. Materials checklist 278 is a list of all materials, i.e. not hardware, software or technical personnel, necessary to implement a particular business solution.

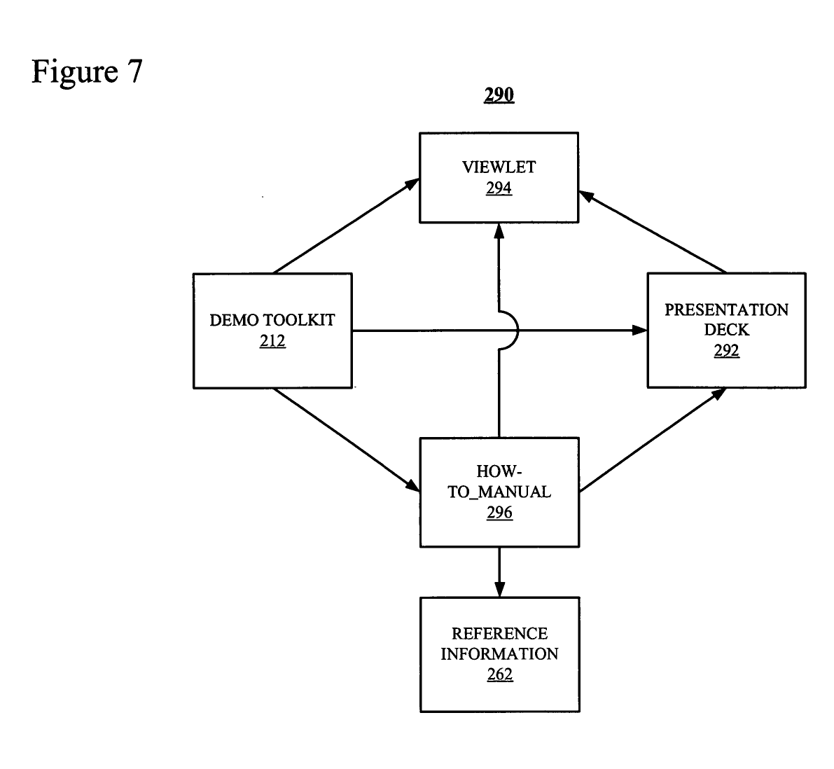

FIG. 7 is a block diagram of a breakdown 290 of demo toolkit 212, first introduced above in conjunction with FIG. 5. Reference information 262 was first introduced above in conjunction with FIG. 6. A presentation deck 292 includes text, diagrams and pictures that illustrated the value of a proposed business solution and its components. Presentation deck can be provided in many possible formats such as, but not limited to, a Microsoft PowerPoint format. Microsoft PowerPoint is published by the Microsoft Corporation of Redmond, Washington. A viewlet 294 is a set of screen shots and other informational content that has been captured with motion into a running movie. Voice may also be recorded to play along with the movie. A how-to-manual 296 is an instruction manual with information on the setup and implementation of a particular business solution.

Demo toolkit 212 includes presentation deck 292, viewlet 294 and how-to-manual 296. Further, both presentation deck 292 and how-to-manual 296 can be viewed on viewlet 294. How-to-manual 296 includes reference information 262.

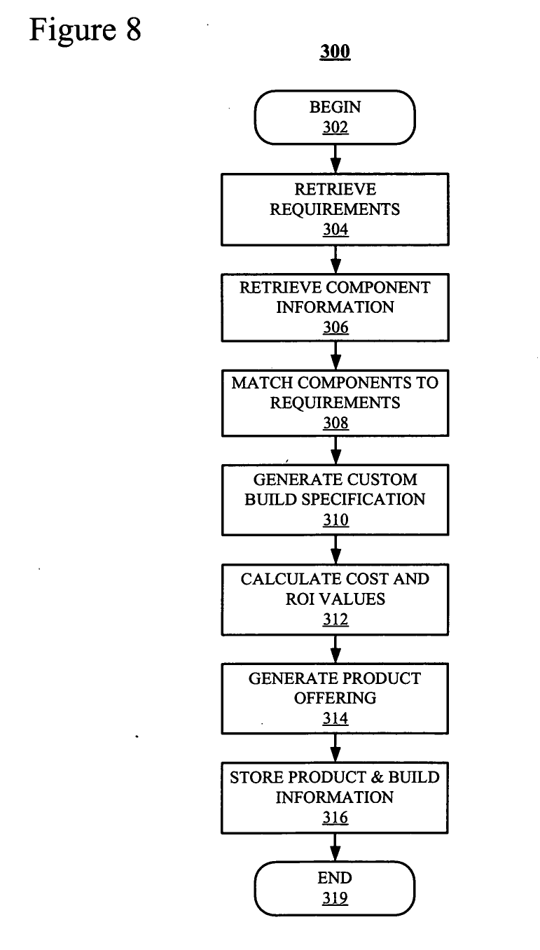

FIG. 8 is a flowchart of a build process 300 that assembles a custom business solution such as deployment package 186 (FIG. 3) according to the claimed subject matter. Process 300 starts in a “Begin” block 302 and proceeds immediately to a “Retrieve Requirements” block 304 during which process 300 collects some of the data necessary to create a business solution, specifically requirements from coded requirements module 162 (FIG. 3). This data includes information from market drivers 160 (FIG. 3) and information provided by the SI relating to the specific business functionality that the SI determines the particular business solution requires. In general, coded requirements 162 includes non-functional requirements, e.g. performance parameters, integration points, etc. that the system must meet.

Process 300 then proceeds to a “Retrieve Component Information” block 306 during which process 300 collects data relating to components, including information such as, but not limited to, each possible component's availability, functionality and dependencies. This information is primarily retrieved from component description module 168 (FIG. 3), component characteristics module 174 (FIG. 3) and component registry 176 (FIG. 3). As mentioned above in conjunction with FIGS. 3 and 4, possible components may include, but are not limited to, hardware, software and related documentation.

Once requirement information is retrieved during block 304 and component information is retrieved during block 306, process 300 proceeds to a “Match Components to Requirements” block 308. It should be noted that blocks 304 and 306 do not need to be executed in any particular order and may even be executed concurrently. During block 310 matching engine 178 (FIG. 3), correlates component information and requirements information, i.e. determines the necessary components for implementing the requirements of the business solution. Process 300 then proceeds to a “Generate Custom Build Specification” block 310 during which process 300 generates custom build specification 180 (FIG. 3) and custom build assets 182 (FIG. 3). Once package descriptor 180 and custom build assets 182 have been generated by solution composer 179, process 300 proceeds to a “Generate Product Offering” block 312 during which process 300 generates custom runtime 188 (FIG. 3) as part of deployment package 186. During a “Store Product & Build Information” block 314, process 314 updates use registry 190 (FIG. 3) and component registry 176 (FIG. 3) so that information about the current business solution is feedback into the system for the improvement of future business solutions. Finally, process 300 proceeds to an “End” block 319 in which process 300 is complete.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A system for estimating expenses in a dynamically generated business solution based upon reusable components, comprising:
a plurality of reusable components;
logic for assigning an expense to each of the reusable components, each expense reflecting the expected cost to operate the corresponding component in a business solution;
logic for selecting a subset of the reusable components of the reusable components to solve the business solution based upon assigned categories corresponding to each of the reusable components; and
logic for generating an estimate of operating expenses of the dynamically generated business system based upon the assigned expenses of the selected subset of reusable components.

2. The system of claim 1, further comprising:
logic for assigning an expected cost to each of the reusable components, each cost reflecting the expected cost of produce and deploy the corresponding component is the business solution; and
logic for generating a return on investment (ROI) value based upon the estimated operating expenses and the estimated costs associated with each of the selected subset of reusable components.

3. The system of claim 2, further comprising logic for replacing the estimated costs and expenses with actual costs and expenses for generating an actual expense and ROI values.

4. The system of claim 2, wherein the ROI value is a time value representing a breakeven point for the business solution.

5. The system of claim 1, wherein the reusable components include hardware, executable logic and user manuals and documentation corresponding to the hardware and executable logic.

6. The system of claim 1, wherein the assigned categories include particular industries associated with a component of the plurality of components, integration points between components, solution areas and the experiences of typical users.

7. The system of claim 6, further comprising logic for augmenting the subset of reusable components based upon the integration points.

8. A method for estimating expenses in a dynamically generated business solution based upon reusable components, comprising:
assigning an expense to each of a plurality of reusable components, each expense reflecting the expected cost to operate the corresponding component in a business solution;
selecting a subset of the reusable components of the reusable components to solve the business solution based upon assigned categories corresponding to each of the reusable components; and
generating an estimate of operating expenses of the dynamically generated business system based upon the assigned expenses of the selected subset of reusable components.

9. The method of claim 8, further comprising:
assigning an expected cost to each of the reusable components, each cost reflecting the expected cost of produce and deploy the corresponding component is the business solution; and
generating a return on investment (ROI) value based upon the estimated operating expenses and the estimated costs associated with each of the selected subset of reusable components.

10. The method of claim 9, further replacing the estimated costs and expenses with actual costs and expenses prior to generating the expense and ROI values.

11. The method of claim 9, wherein the ROI value is a time value representing a breakeven point for the business solution.

12. The method of claim 8, wherein the reusable components include hardware, executable logic and user manuals and documentation corresponding to the hardware and executable logic.

13. The method of claim 1, wherein the assigned categories include particular industries associated with a component of the plurality of components, integration points between components, solution areas and the experiences of typical users.

14. The method of claim 6, further comprising augmenting the subset of reusable components based upon the integration points.

15. A computer programming product for estimating expenses in a dynamically generated business solution based upon reusable components, comprising:
a memory;
logic, stored on the memory, for assigning an expense to each reusable components of a plurality of reusable components, each expense reflecting the expected cost to operate the corresponding component in a business solution;
logic, stored on the memory, for selecting a subset of the reusable components of the reusable components to solve the business solution based upon assigned categories corresponding to each of the reusable components; and
logic, stored on the memory, for generating an estimate of operating expenses of the dynamically generated business system based upon the assigned expenses of the selected subset of reusable components.

16. The computer programming product of claim 15, further comprising:
logic, stored on the memory, for assigning an expected cost to each of the reusable components, each cost reflecting the expected cost of produce and deploy the corresponding component is the business solution; and
logic, stored on the memory, for generating a return on investment (ROI) value based upon the estimated operating expenses and the estimated costs associated with each of the selected subset of reusable components.

17. The computer programming product of claim 16, further comprising logic, stored on the memory, for replacing the estimated costs and expenses with actual costs and expenses for generating an actual expense and ROI values.

18. The computer programming product of claim 16, wherein the ROI value is a time value representing a breakeven point for the business solution.

19. The computer programming product of claim 15, wherein the reusable components include hardware, executable logic and user manuals and documentation corresponding to the hardware and executable logic.

20. The computer programming product of claim 15, wherein the assigned categories include particular industries associated with a component of the plurality of components, integration points between components, solution areas and the experiences of typical users.
